(19) United States
(12) Patent Application Publication
(10) Pub. No.: US 2007/0278208 A1
(43) Pub. Date: Dec. 6, 2007

(54) Safety interlock tool

(76) Inventor: Timothy Mullenix, St. Helens, OR (US)

Correspondence Address: ROBERT IRELAND, PO BOX 273, BANKS, OR, 97106, US

(21) Appl. No.: 11/447,259

(22) Filed: Jun. 6, 2006

(51) Int. Cl. A21B 1/00

(52) U.S. Cl. 219/413

(57) ABSTRACT

A simple tool for compressing a safety interlock switch comprising a first portion and a second portion, and a magnet connected to the first portion, allowing the magnet to fixedly contact or stick to the metal box of the HVAC unit, compressing the safety interlock switch with the second portion.

### CROSS REFERENCES TO RELATED APPLICATIONS

N/A

### STATEMENT REGARDING FEDERALL SPONSORED RESEARCH/DEVELOPMENT

This invention is not the product of any Federally Sponsored Research or Development.

### FIELD OF INVENTION

Applicant's device relates to a hand tool utilized during the service of heating or air conditioning units, more particularly, a tool used to engage the “open door” safety interlock externally, located on the heating and air conditioning case.

### BACKGROUND OF THE INVENTION

Heating and Air Conditioning Units (HVAC) are well known in the art and understood to be commonplace in industrial and residential applications. The common HVAC configuration includes a containment box that houses the electrical components and filter. Said containment box is constructed of ferrous metal and usually has an opening covered by an access door or panel. In between the surfaces of the access door and the containment box is a safety interlock switch (herein “Switch”). Said Switch is compressed when the access door is in the closed position. When the access door is opened for maintenance or filter replacement the Switch is depressed. In the depressed position the Switch shuts off the electrical power to the HVAC unit for safety. However, a trained professional would be unable to test the electrical components without electrical power to the HVAC unit. Common methods used by HVAC professionals for circumventing the purpose of the Switch is to tape over it or jam a small knife blade into the Switch forcing the it to remain in the “closed” position while performing diagnosis. The circumvention of the Switch reconnects the electrical power to the HVAC unit facilitating “hot” testing and diagnosis. However, technicians often forget to remove the tape from the Switch after the maintenance or repair is complete. The access door is closed over the tape and the Switch is disabled, creating dangerous circumstances. An untrained person who opens the access door to replace a filter is then exposed to high electrical voltages and currents.

U.S. Pat. No. 5,281,857 (Keese, Jan. 25, 1994) discloses a self-checking interlock control system. The art relates to a device that ensures all safety interlocks are working properly and have not been disabled or have failed. The art described in #857 pertains to the related field of technology, but fails to temporarily disable the safety interlock switch.

U.S. Pat. No. 5,816,059 (Ficchi Jr., Oct. 6, 1998) is an artificial input controller for HVAC units. The art relates to artificially controlling the inputs of the HVAC unit, including the safety interlock switch. However, #059 utilizes an expensive and complicated controller that interfaces with only certain HVAC units via a ribbon cable interface.

U.S. Pat. No. 5,870,317 (Barnett, Feb. 9, 1999) relates to a remote and proximal testing device that simulates a breach of the safety interlocks. The art relates to testing and monitoring safety interlocks and other boundary switches that shut off power to equipment. The art disclosed in #317 does not artificially simulate the access door being in the closed position, #317 simply monitors the sensors.

### OBJECTS OF THE INVENTION

It is an object of the instant device to provide a simple tool that holds down the safety interlock switch of a HVAC unit when the access door is open.

A further object of the instant device is to utilize a magnet in holding down the Switch of a HVAC unit when the access door is open.

It is yet a further object of the instant device for the simple tool to be small enough to fit into a pocket.

It is yet a further object of the instant device to be durable in construction, function easily, and be economical in price.

### SUMMARY OF THE INVENTION

The above objects are provided for the safety interlock tool. The instant device is simple in construction and elegant in function, having the magnet holdingly affix the tool to the containment box at a location where the tool compresses the Switch, simulating an access door in closed condition. The tool is removably engageable with the containment box and fits easily in a technician's pocket.

The above objects are accomplished by a simple tool for compressing a Switch comprising a first portion, a second portion connected by hinge or other method. The first portion should have an integrated magnet constructed and arranged to allow the magnet to fixedly contact the metal containment box of the HVAC unit, while compressing the Switch with the second portion.

A secondary and unexpected benefit of the device is that the safety interlock tool compresses the Switch while preventing the door from being closed, eliminating the chance that the technician could leave the Switch disabled, causing a dangerous circumstance for the home owner. The tool magnetically attaches to the containment box, while removably engaging the Switch into the compressed position. In holding the Switch in the compressed position, the tool simulates the access door being in the closed position. Once the technician completes maintenance or diagnosis, the tool is removed from the HVAC unit, the Switch is no longer compressed, and the access door can be closed with all safety features intact and operational.

### DRAWINGS

DESCRIPTION FIG. 1:

FIG. 1 is a side view of the device, utilizing a hinge and rectangular first and second portions, demonstrating the open and closed positions.

DESCRIPTION FIG. 2:

FIG. 2 describes a containment box (HVAC) (6) commonly used for heating and air conditioning units. The safety switch (7) protrudes from the edge of the metal containment box (6).

DESCRIPTION FIG. 3:

FIG. 3 demonstrates the device described in FIG. 1, removably engaged with the metal containment box (6) of FIG. 2.

DESCRIPTION FIG. 4:

FIG. 4 is a perspective drawing of the device in the hinged embodiment.

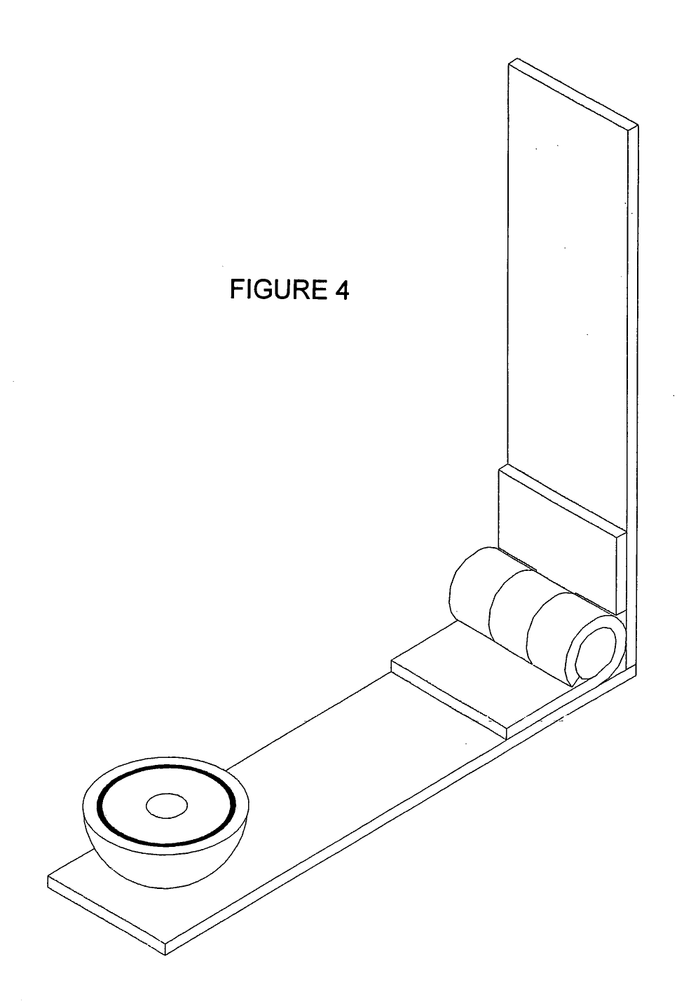

### DESCRIPTION OF PREFERRED EMBODIMENT

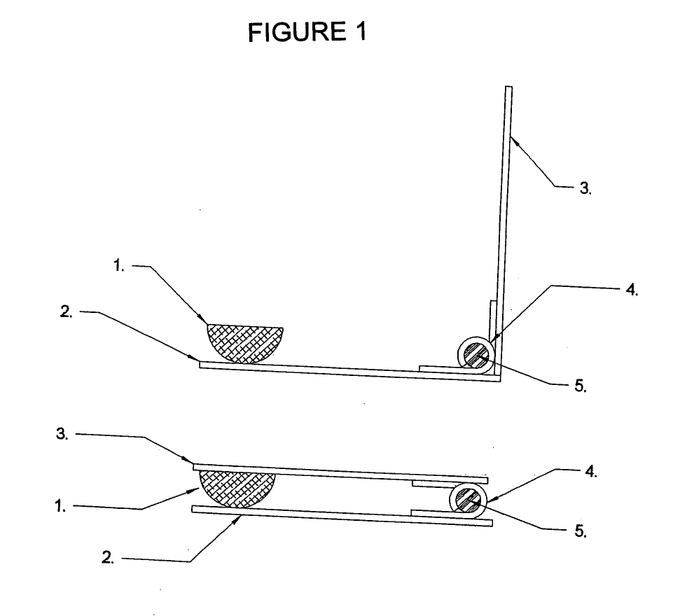

FIG. 1 is a side view of the preferred embodiment having a magnet (1) integrated on the internal surface of the first portion (2). Hingedly connected to a second portion (3), the first and second portions swinging freely about the vertical hinged axis (5), keeping the internal surfaces of the device parallel to one another.

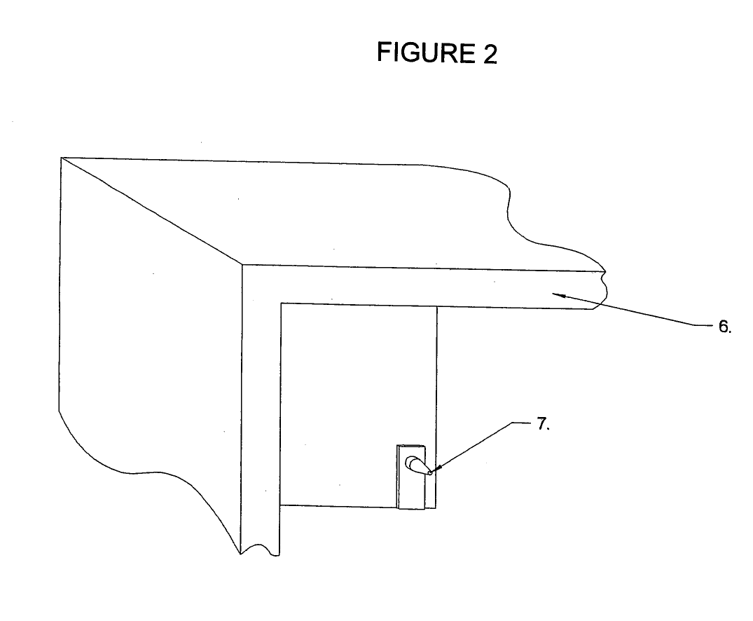

This is only one embodiment, drawn to illustrate the components as assembled and in no way limits the scope of claim 2 wherein the device does not have a hinge. The hinged embodiment as demonstrated utilizes a ferrous magnet (1) attached to the first portion (2) of the device, providing the removable and engagable mechanism that interconnects to the metal containment box of the HVAC unit. A second portion (3) applies compression pressure to the safety interlock switch (described in FIGS. 2 & 3), thus compressing the Switch (7). The hinge (4) connects the first portion (2) and second portion (3), allowing for motion along the vertical hinged axis (5) ranging from the closed position (lower drawing), to an open position (upper drawing), wherein the vertical hinged axis (5) allows for adjustment to attach the magnet (1) to the containment box while compressing the Switch.

FIG. 2 is a perspective view demonstrating a metal containment box commonly used to contain heating and air conditioning hardware (HVAC). The described box having a hinged door and a safety switch constructed and arranged to be “closed” or conducting, when the hinged door is in the closed position; and “open” or not conducting when the hinged door is open not enclosing the open side of the metal box. This feature is what allows access to the internal unit The purpose of the safety switch is to “shut-off” the power going to the HVAC unit during maintenance, cleaning, and inspection. The safety switch protects homeowners from electrical shock when changing filters, inspections, and resetting circuit breakers.

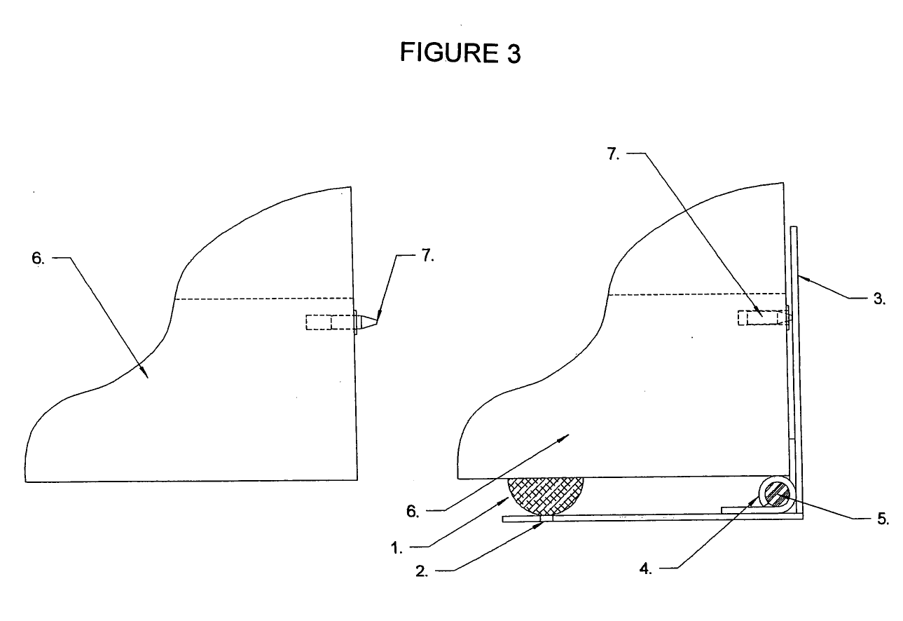

FIG. 3 is a perspective view from an upper position, demonstrating the hinged tool shown in FIG. 1, removably engaged to the outside of the open metal box shown in FIG. 2. The hinged tool utilizes the magnet integrated in the long rectangular portion of the hinged tool to securely fasten and interconnect with the outside of the metal box. The interlock switch (7) is then depressed into the “closed” position via the (3) second portion (7) of the device. With the interlock switch (7) in the “closed” position, the HVAC would still have power “HOT” to the HVAC circuitry allowing the facilitating a technician the ability to perform diagnostics. The hinged tool also prevents the door from closing, thus averting the dangerous situation where in the switch would be in the “closed” position, while the door is open, exposing the homeowner to bare wires and electrical shock.

What is claimed is:

1. A simple tool for compressing a safety interlock switch comprising:
a first portion;
a second portion;
a hinge connecting the first and second portions;
a magnet connected to the first portion, constructed and arranged to allow the magnet to fixedly contact the metal box of the HVAC unit compressing the safety interlock switch with the second portion.

2. The simple tool of claim 1 wherein the first and second portion are connected without a hinge.
